(19) United States
(12) Patent Application Publication
(10) Pub. No.: US 2016/0366378 A1
(43) Pub. Date: Dec. 15, 2016

(54) FLAT SCREEN TELEVISION SCREEN PROTECTOR

(71) Applicant: Daniel Nagel, Whittier, CA (US)

(72) Inventor: Daniel Nagel, Whittier, CA (US)

(21) Appl. No.: 14/736,224

(22) Filed: Jun. 10, 2015

(51) Int. Cl. H04N 9/31

(52) U.S. Cl. CPC H04N 9/3141

(57) ABSTRACT

A television screen protector assembly for mounting to a conventional television and protecting the screen panel of the television on which it is mounting. The television screen protector assembly includes a pair of holding brackets, each having an attaching surface for attaching to the television and a receiving slot for slidingly receiving a removable protecting screen (or “removable screen”) and a pair of impact brackets, each having an attaching surface, impact pads for preventing the protecting screen from impacting the television and a swinging closure for enabling selective control of the insertion and removal of the removable screen in the receiving slots. The removable screen defines a rigid, transparent rectangular member that while held in place by the brackets, shields the screen panel of a conventional television.

### BACKGROUND OF THE INVENTION

Field of the Invention

This invention relates generally to a panel display screen protection apparatus and, more particularly, to a screen protector with support brackets for a flat screen television.

Description of the Prior Art

The proliferation televisions with flat panel display screens has increased in recent years. Accompanying this increase has been an increase in the sophistication of display technologies, with screens employing various technologies, such as LCD, plasma, and LED screens, continually improving in quality. The actual display panel is commonly the most expensive part of such televisions, but unfortunately, it remains among the most fragile components. A problem which still exists, therefore, is that with the technology and design of contemporary flat screen televisions, the most fragile aspect of the device is generally placed to be the most accessible (and thus most prone to being accidentally or inadvertently hit with objects. Thus, there remains a need for a flat screen television screen protector that could be placed in front of a television's display panel to protect it from projectiles. It would be helpful if such a flat screen television screen protector eliminated was mountable directly on a television to be held in front of its screen. It would be additionally desirable for such a flat screen television screen protector to include a removable protector screen to enable easy cleaning and maintenance.

The Applicant's invention described herein provides for a flat screen television screen protector adapted to allow a user to protect the display panel on a television without otherwise affecting the use and operation of the television. The primary components in Applicant's flat screen television screen protector are a pair of holding brackets, a pair of impact brackets, and a removable screen. When in operation, the flat screen television screen protector enables the fragile display panel of a television to be shielded by a durable mounted structure that prevents inadvertent or accidental contact with the screen. As a result, many of the limitations imposed by prior art structures are removed.

### SUMMARY OF THE INVENTION

A television screen protector assembly for mounting to a conventional television and protecting the screen panel of the television on which it is mounting. The television screen protector assembly includes a pair of holding brackets, each having an attaching surface for attaching to the television and a receiving slot for slidingly receiving a removable protecting screen (or “removable screen”) and a pair of impact brackets, each having an attaching surface, impact pads for preventing the protecting screen from impacting the television and a swinging closure for enabling selective control of the insertion and removal of the removable screen in the receiving slots. The removable screen defines a rigid, transparent rectangular member that while held in place by the brackets, shields the screen panel of a conventional television.

It is an object of this invention to provide an extension bar for a flat screen television screen protector that could be placed in front of a television's display panel to protect it from projectiles.

It is another object of this invention to provide a flat screen television screen protector that eliminated was mountable directly on a television to be held in front of its screen.

It is yet another object of this invention to provide a flat screen television screen protector that includes a removable protector screen to enable easy cleaning and maintenance.

These and other objects will be apparent to one of skill in the art.

### BRIEF DESCRIPTION OF THE DRAWINGS

FIG. 1 is a side elevational view of a television screen protector assembly built in accordance with the present invention in place on a flat screen television with its impact brackets in shadow.

FIG. 2 is a side elevational view of the holding brackets of a television screen protector assembly built in accordance with the present invention.

FIG. 3 is a front elevational view of the top holding bracket of a television screen protector assembly built in accordance with the present invention.

FIG. 4 is a back elevational view of the top holding bracket of a television screen protector assembly built in accordance with the present invention.

FIG. 5 is a side elevational view of the impact brackets of a television screen protector assembly built in accordance with the present invention.

FIG. 6 is a front elevational view of the right impact bracket of a television screen protector assembly built in accordance with the present invention with its swinging closures in the closed position.

FIG. 7 is a back elevational view of the right impact bracket of a television screen protector assembly built in accordance with the present invention with its swinging closures in the open position.

### DETAILED DESCRIPTION OF THE INVENTION

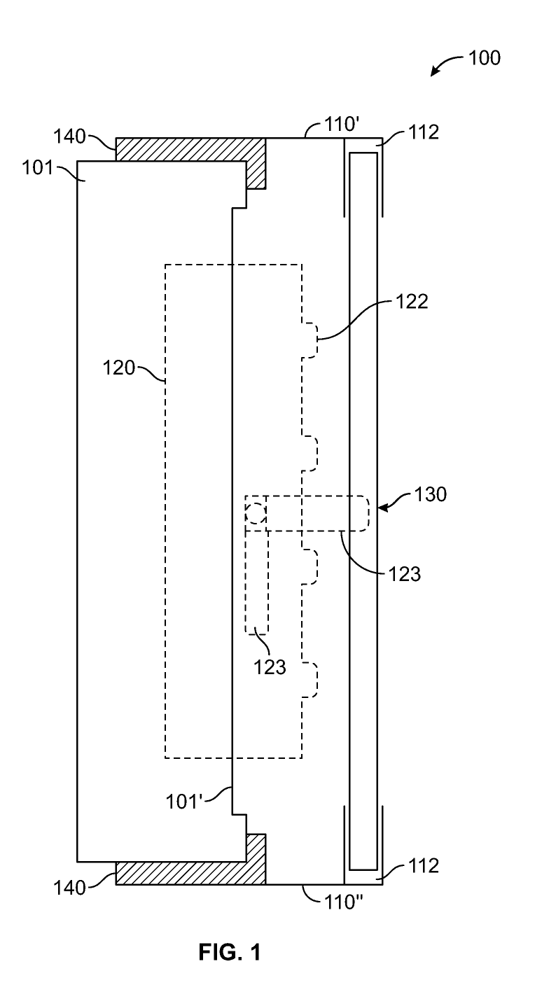

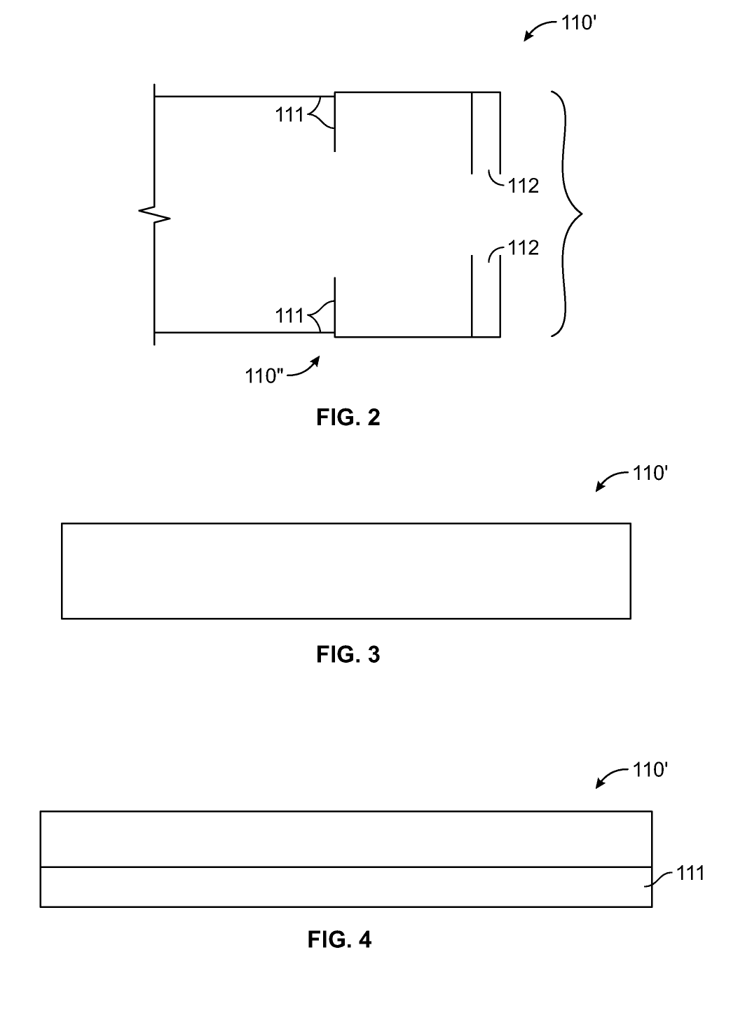

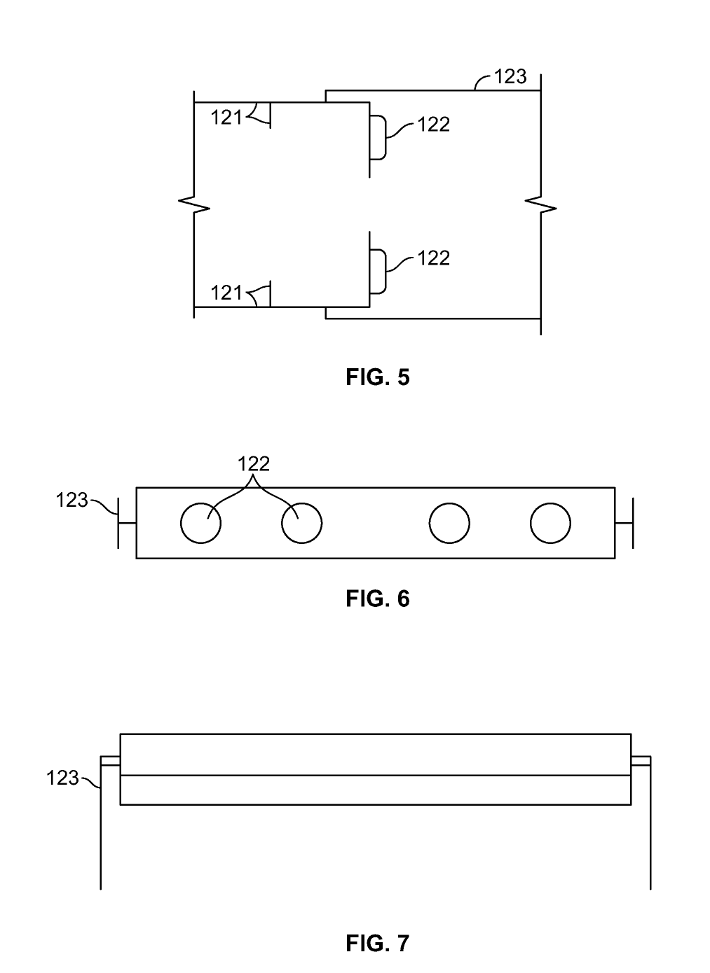

Referring now to the drawings and in particular FIGS. 1, 2, 3, 4, 5, 6, and 7, a television screen protector assembly 100 is shown having a pair of holding brackets 110′, 110″ (collectively 110), a pair of impact brackets 120′, 120″ (collectively 120), and a removable screen 130. The holding brackets 110 and impact brackets 120 each define a rigid structure that includes an orthogonal television attaching surface 111 that enables each individually to be attached to the edge a conventional flat screen television 101, contacting both the top surface and front surface immediately adjacent to the target edge. The removable screen 130 defines a rigid, transparent rectangular member sized to cover the screen panel 101′ of a conventional television set fully when mounted in place on the holding brackets 110, thereby providing a shield operative to protect the screen panel 101′ from being contacted by items which may be close or moved close to the television 101.

The holding brackets 110 include a top holding bracket 110′ and an identical a bottom holding bracket 110″, which are differentiated by their intended placement on the television 101. The holding brackets 110 are each defined by the orthogonal attaching surface 111 and a receiving slot 112 that is sized such that when the holding brackets 110 are in place on the television, the removable screen 130 can be slid laterally in or out of the two slots 112 simultaneously and be held in place between the two slots 112.

The impact brackets 120 include a left impact bracket 120′ and an identical right impact bracket 120″, which, as with the holding brackets 110, are differentiated by their intended placement on the television 101. Similar to the holding brackets 110, the impact brackets 120 each include an orthogonal side attaching surface 121 that enable them to be fastened to the edge of a target television 101. The impact brackets 120 additionally include a plurality of impact pads 122 and a swinging closure 123. The impact pads 122 are positioned such that they face the screen 130 when the impact brackets 120 are in place on the television 101 so as to provide a redundant (in relation to the receiving slots 112) support structure to prevent the screen 130 from being pushed or otherwise moved into the television 101. The swinging closure 123 defines a rigid, elongated member adapted to be swung from a closed position defined by it extending beyond the screen 130 so as to form a barrier that prevents the screen 130 from being slide out of the receiving slots 112 and an open position in which it does not obstruct the lateral slide path of the screen 130.

In one embodiment, the holding brackets 110 and impact brackets 120 are attached to the television 101 through an adhesive 140. A removable glue defines the adhesive in one embodiment. In an alternate embodiment, a fabric hook and loop fastener system is employed to attach the holding brackets 110 and impact brackets 120 to the television 101.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A television screen protector assembly for protecting a screen panel on a conventional flat screen television, comprising:
a pair of discrete holding brackets, each configured to attach to the edge of a television;
a pair of discrete impact brackets, each configured to attach to the edge of a television;
a transparent removable screen, wherein said removable screen is selectively integrated with the holding brackets; and
said holding brackets, when attached on a target television, adapted to hold the removable screen in front of the screen panel of the target television.

2. The television screen protector assembly of claim 1, wherein the holding brackets are configured to attach to the edge of a target television with an orthogonal television attaching surface.

3. The television screen protector assembly of claim 1, wherein the holding brackets each include a receiving slot for holding the removable screen.

4. The television screen protector assembly of claim 1, wherein the impact brackets are configured to attach to the edge of a target television with an orthogonal side attaching surface.

5. The television screen protector assembly of claim 1, wherein the impact brackets include a plurality of impact pads positioned such that when the impact brackets are attached to the television, the impact pads are located between the removable screen and the screen panel of the target television.

6. The television screen protector assembly of claim 1, wherein the impact brackets include a closure member adapted to be selectively positioned in an open position and a closed position.

7. A television screen protector assembly for protecting a screen panel on a conventional flat screen television, comprising:
a pair of discrete holding brackets, each configured to attach to the edge of a television with an orthogonal television attaching surface;
a pair of discrete impact brackets, each configured to attach to the edge of a television with an orthogonal side attaching surface;
a transparent removable screen, wherein said removable screen is selectively integrated with the holding brackets; and
said holding brackets, when attached on a target television, adapted to hold the removable screen in front of the screen panel of the target television.

8. The television screen protector assembly of claim 7, wherein the holding brackets each include a receiving slot for holding the removable screen.

9. The television screen protector assembly of claim 8, wherein the impact brackets include a plurality of impact pads positioned such that when the impact brackets are attached to the television, the impact pads are located between the removable screen and the screen panel of the target television.

10. The television screen protector assembly of claim 9, wherein the impact brackets include a closure member adapted to be selectively positioned in an open position and a closed position.
